(19) United States
(12) Patent Application Publication
(10) Pub. No.: US 2016/0274694 A1
(43) Pub. Date: Sep. 22, 2016

(54) TOUCH SENSOR WITH MULTILAYER STACK HAVING IMPROVED FLEXURAL STRENGTH

(71) Applicant: 3M INNOVATIVE PROPERTIES COMPANY, St. Paul, MN (US)

(72) Inventors: Matthew J. King, Allston, MA (US); Tanya Stanley, Woburn, MA (US); Michael T. Howard, Dracut, MA (US)

(21) Appl. No.: 15/024,926

(22) PCT Filed: Nov. 24, 2014
(86) PCT No.: PCT/US14/67039

§ 371 Date: Mar. 25, 2016

Related U.S. Application Data
(60) Provisional application No. 61/915,605, filed on Dec. 13, 2013.

(51) Int. Cl. G06F 3/044

(52) U.S. Cl. CPC G06F 3/044

(57) ABSTRACT

A multilayer stack for use in a touch sensor is provided, including a base substrate covering viewing and border areas of the multilayer stack and an optically opaque border layer that defines a step proximate to and extending along a perimeter of the viewing area. The multilayer stack also includes an optically transparent adhesive layer disposed on the base substrate and the border layer and covering the viewing and border areas of the multilayer stack. The multilayer stack further includes a number of discrete spaced apart optically transparent electrodes disposed on the adhesive layer, each electrode extending across the step, and a number of discrete spaced apart electrically conductive pads disposed in the border, but not the viewing, area of the multilayer stack, each pad being posed on and making physical contact with a different corresponding electrode over a contact region.

### TECHNICAL FIELD

The present disclosure relates generally to touch sensors. In particular, the present invention relates to touch sensors including a multilayer stack having improved flexural strength.

### BACKGROUND

Touch sensitive devices can be implemented to allow a user to interface with electronic systems and displays conveniently, for example, by providing a display input that is typically prompted by a visual in the display for user-friendly interaction and engagement. In some instances, the display input complements other input tools such as mechanical buttons, keypads and keyboards. In other instances, the display input acts as an independent tool for reducing or eliminating the need for mechanical buttons, keypads, keyboards and pointing devices. For example, a user can carry out a complicated sequence of instructions by simply touching an on-display touch screen at a location identified by an icon or by touching a displayed icon in conjunction with another user input.

There are several types of technologies for implementing a touch sensitive device including, for example, resistive, infrared, capacitive, surface acoustic wave, electromagnetic, near field imaging, etc., and combinations of these technologies. Touch sensitive devices that use capacitive touch sensing devices have been found to work well in a number of applications. In many touch sensitive devices, the input is sensed when a conductive object in the sensor is capacitively coupled to a conductive touch implement such as a user's finger. In some cases, when two electrically conductive members come into proximity with one another without actually touching, a capacitance is formed therebetween. In the case of a capacitive touch sensitive device, as an object such as a finger approaches the touch sensing surface, a tiny capacitance forms between the object and the sensing points in close proximity to the object. By detecting changes in capacitance at each of the sensing points and noting the position of the sensing points, the sensing circuit can recognize multiple objects and determine the characteristics of the object as it is moved across the touch surface.

Different techniques have been used to measure touch based on such capacitive changes. One technique measures change in capacitance-to-ground, whereby the status of an electrode is understood based on the capacitive condition of a signal that is applied to the electrode before a touch would alter the signal. A touch in proximity to the electrode causes signal current to flow from the electrode, through an object such as a finger or touch stylus, to electrical ground. By detecting the change in capacitance at the electrode and also at various other points on the touch screen, the sensing circuit can note the position of the points and thereby recognize the location on the screen where the touch occurred. Also, depending on the complexity of the sensing circuit and related processing, various characteristics of the touch can be assessed for other purposes such as determining whether the touch is one of multiple touches, and whether the touch is moving and/or satisfies expected characteristics for certain types of user inputs.

Another known technique monitors touch-related capacitive changes by applying a signal to a signal-drive electrode, which is capacitively coupled to a signal-receive (or “sense”) electrode by an electric field. As these terms connote, with the signal-receive electrode returning an expected signal from the signal-drive electrode, an expected signal (capacitive charge) coupling between the two electrodes can be used to indicate the touch-related status of a location associated with the two electrodes. Upon or in response to an actual or perceived touch at/near the location, the status of signal coupling changes, and this change is reflected by a reduction in the capacitive coupling.

The conductor in many capacitive touch screens is constructed from a thin, rigid, and brittle film of Indium Tin Oxide (ITO), or similar material. This patterned thin film is deposited onto a flexible substrate, for instance polyethylene terephthalate (PET), by means of physical vapor deposition equipment. A layer of optically clear adhesive (OCA), in film or liquid form, is typically used to attach the non-conducting side of the substrate to a display device, e.g., via a glass substrate. A z-axis conductive adhesive and a flexible printed circuit are used to attach the conducting side of the substrate to an electronic device. Despite the numerous optical and low-cost benefits of such constructions, a mismatch in the material properties of these layers can cause high manufacturing yield loss during the flexible printed circuit attachment process step. Under the compressive stress required to compress or embed the z-axis adhesive, the OCA generally permanently deforms plastically due to creep and the temperature required for curing the z-axis adhesive increases the severity of this deformation. As the thin film conductor is rigid and brittle, it typically cannot match the deformation while maintaining the desired material and electrical properties. Hence, the thin film conductor fractures if the yield stress is reached, and electricity cannot be conducted except at prohibitively high resistances.

The above issues are examples of those that have presented challenges to the effective designs of touch-sensitive displays.

### SUMMARY

In a first aspect, the present invention provides a multilayer stack for use in a touch sensor and having a border area surrounding a viewing area adapted to face a viewer and be touch sensitive. The multilayer stack includes a base substrate covering the viewing and border areas of the multilayer stack, and an optically opaque border layer disposed in and covering the border, but not the viewing, area of the multilayer stack. The border layer defines a step proximate to and extending along a perimeter of the viewing area and having a step height of at least 5 microns. The multilayer stack also includes an optically transparent adhesive layer disposed on the base substrate and the border layer and covering the viewing and border areas of the multilayer stack. A maximum height variation of a major surface of the optically transparent adhesive layer away from the viewing area in a region corresponding to the step is less than the step height. The multilayer stack further includes a number of discrete spaced apart optically transparent electrodes disposed on the adhesive layer, each electrode extending across the step, and a number of discrete spaced apart electrically conductive pads disposed in the border, but not the viewing, area of the multilayer stack, each pad being disposed on and making physical contact with a different corresponding electrode over a contact region.

In a second aspect, the present invention provides a multilayer stack for use in a touch sensor and having a border area surrounding a viewing area, the viewing area adapted to face a viewer and be touch sensitive. The multilayer stack includes a base substrate covering the viewing and border areas of the multilayer stack, an optically opaque border layer disposed in and covering the border, but not the viewing, area of the multilayer stack, the border layer defining a step proximate to and extending along a perimeter of the viewing area and having a step height of at least 5 microns; and an optically transparent adhesive layer disposed on the base substrate and the border layer and covering the viewing and border areas of the multilayer stack. The multilayer stack further includes a plurality of discrete spaced apart optically transparent electrodes disposed on the adhesive layer, each electrode extending across the step, and a plurality of discrete spaced apart electrically conductive pads disposed in the border, but not the viewing, area of the multilayer stack, each pad being disposed on and making physical contact with a different corresponding electrode over a contact region. Any void or bubble formed between the base substrate, the optically opaque border layer and the optically transparent adhesive layer at the step is substantially unresolvable by a human eye viewing the multilayer stack at a normal viewing distance.

In a third aspect, the present invention provides a touch sensor having a touch sensitive area surrounded by a border area, a vertical step separating the border area from the touch sensitive area and extending along a perimeter of the touch sensitive area, the step having a step height of at least 5 microns. The touch sensor further includes an optically transparent adhesive layer disposed on and covering the touch sensitive and border areas and having a minimum thickness of at least 30 microns, an optically transparent electrode disposed on the optically transparent adhesive layer in the border area and extending across the vertical step, and an electrically conductive pad disposed on the electrode in the border area.

In a fourth aspect, the present invention provides a method of making a multilayer stack for use in a touch sensor and having a border area surrounding a viewing area adapted to face a viewer and be touch sensitive. The method includes covering the viewing and border areas of the multilayer stack with a base substrate and disposing an optically opaque border layer in and covering the border, but not the viewing, area of the multilayer stack, the border layer defining a step proximate to and extending along a perimeter of the viewing area and having a step height of at least 5 microns. The method further includes disposing an optically transparent adhesive layer on the base substrate and the border layer and covering the viewing and border areas of the multilayer stack, a maximum height variation of a major surface of the optically transparent adhesive layer away from the viewing area in a region corresponding to the step being less than the step height, disposing a plurality of discrete spaced apart optically transparent electrodes on the adhesive layer, each electrode extending across the step, and disposing a plurality of discrete spaced apart electrically conductive pads in the border, but not the viewing, area of the multilayer stack. Each pad is disposed on and makes physical contact with a different corresponding electrode over a contact region.

The above summary of the present invention is not intended to describe each disclosed embodiment or every implementation of the present invention. The Figures and detailed description that follow below more particularly exemplify illustrative embodiments.

### BRIEF DESCRIPTION OF THE DRAWINGS

FIG. 1 shows a schematic view of a touch device;

FIG. 2 shows a schematic cross-sectional view of a multilayer stack of a touch sensor.

FIG. 3 shows a schematic cross-sectional view of a multilayer stack of a touch sensor for evaluating conductive materials.

FIG. 4 is a schematic top view of four ink jetting patterns on a portion of an ITO trace.

FIG. 5 is a photo of ink jetted conductive pads.

FIG. 6 is a schematic top view of a portion of an ITO trace including an ink jetted conductive pad.

FIG. 7 is a graph of the effect on line resistance by the presence of an ink jetted carbon conductive pad.

FIG. 8 is a graph of the effect on line resistance by the presence of an ink jetted silver conductive pad.

FIG. 9 is a graph of contour plots of average resistance of electrodes including a carbon conductive pad.

FIG. 10 is a graph of contour plots of average resistance of electrodes including a silver conductive pad.

### DETAILED DESCRIPTION

In the following detailed description of the preferred embodiments, reference is made to the accompanying drawings that form a part hereof. The accompanying drawings show, by way of illustration, specific embodiments in which the invention may be practiced. It is to be understood that other embodiments may be utilized, and structural or logical changes may be made without departing from the scope of the present invention. The following detailed description, therefore, is not to be taken in a limiting sense, and the scope of the invention is defined by the appended claims.

Aspects of the present disclosure are believed to be applicable to a variety of different types of touch-sensitive display systems, devices and methods, including those involving a multilayer stack.

According to certain embodiments, the present disclosure is directed to touch-sensitive apparatuses of the type that includes a touch surface circuit configured to facilitate a change in a coupling capacitance in response to a capacitance-altering touch. The apparatus includes a sense circuit that provides a responsive signal having transient portions for characterizing positive-going transitions towards an upper signal level and negative-going transitions towards a lower signal level. An amplification circuit is then used for amplifying and processing the signals, in response to the time-varying input parameters. The amplification circuit adjusts the gain for the transient portions relative to gain for portions of the response signals between the transient portions, and thereby suppresses RF interference, such as in the form of odd and/or even harmonics, to provide a noise filtered output for determining positions of capacitance-altering touches on the touch surface.

In one aspect, the present invention provides a multilayer stack for use in a touch sensor and having a border area surrounding a viewing area adapted to face a viewer and be touch sensitive. The multilayer stack includes a base substrate covering the viewing and border areas of the multilayer stack, and an optically opaque border layer disposed in and covering the border, but not the viewing, area of the multilayer stack. The border layer defines a step proximate to and extending along a perimeter of the viewing area and having a step height of at least 5 microns. The multilayer stack also includes an optically transparent adhesive layer disposed on the base substrate and the border layer and covering the viewing and border areas of the multilayer stack. A maximum height variation of a major surface of the optically transparent adhesive layer away from the viewing area in a region corresponding to the step is less than the step height. The multilayer stack further includes a number of discrete spaced apart optically transparent electrodes disposed on the adhesive layer, each electrode extending across the step, and a number of discrete spaced apart electrically conductive pads disposed in the border, but not the viewing, area of the multilayer stack, each pad being disposed on and making physical contact with a different corresponding electrode over a contact region.

In another aspect, the present invention provides a multilayer stack for use in a touch sensor and having a border area surrounding a viewing area, the viewing area adapted to face a viewer and be touch sensitive. The multilayer stack includes a base substrate covering the viewing and border areas of the multilayer stack, an optically opaque border layer disposed in and covering the border, but not the viewing, area of the multilayer stack, the border layer defining a step proximate to and extending along a perimeter of the viewing area and having a step height of at least 5 microns; and an optically transparent adhesive layer disposed on the base substrate and the border layer and covering the viewing and border areas of the multilayer stack. The multilayer stack further includes a plurality of discrete spaced apart optically transparent electrodes disposed on the adhesive layer, each electrode extending across the step, and a plurality of discrete spaced apart electrically conductive pads disposed in the border, but not the viewing, area of the multilayer stack, each pad being disposed on and making physical contact with a different corresponding electrode over a contact region. Any void or bubble formed between the base substrate, the optically opaque border layer and the optically transparent adhesive layer at the step is substantially unresolvable by a human eye viewing the multilayer stack at a normal viewing distance.

In a further aspect, the present invention provides a touch sensor having a touch sensitive area surrounded by a border area, a vertical step separating the border area from the touch sensitive area and extending along a perimeter of the touch sensitive area, the step having a step height of at least 5 microns. The touch sensor further includes an optically transparent adhesive layer disposed on and covering the touch sensitive and border areas and having a minimum thickness of at least 30 microns, an optically transparent electrode disposed on the optically transparent adhesive layer in the border area and extending across the vertical step, and an electrically conductive pad disposed on the electrode in the border area.

In an additional aspect, the present invention provides a method of making a multilayer stack for use in a touch sensor and having a border area surrounding a viewing area adapted to face a viewer and be touch sensitive. The method includes covering the viewing and border areas of the multilayer stack with a base substrate and disposing an optically opaque border layer in and covering the border, but not the viewing, area of the multilayer stack, the border layer defining a step proximate to and extending along a perimeter of the viewing area and having a step height of at least 5 microns. The method further includes disposing an optically transparent adhesive layer on the base substrate and the border layer and covering the viewing and border areas of the multilayer stack, a maximum height variation of a major surface of the optically transparent adhesive layer away from the viewing area in a region corresponding to the step being less than the step height, disposing a plurality of discrete spaced apart optically transparent electrodes on the adhesive layer, each electrode extending across the step, and disposing a plurality of discrete spaced apart electrically conductive pads in the border, but not the viewing, area of the multilayer stack. Each pad is disposed on and makes physical contact with a different corresponding electrode over a contact region.

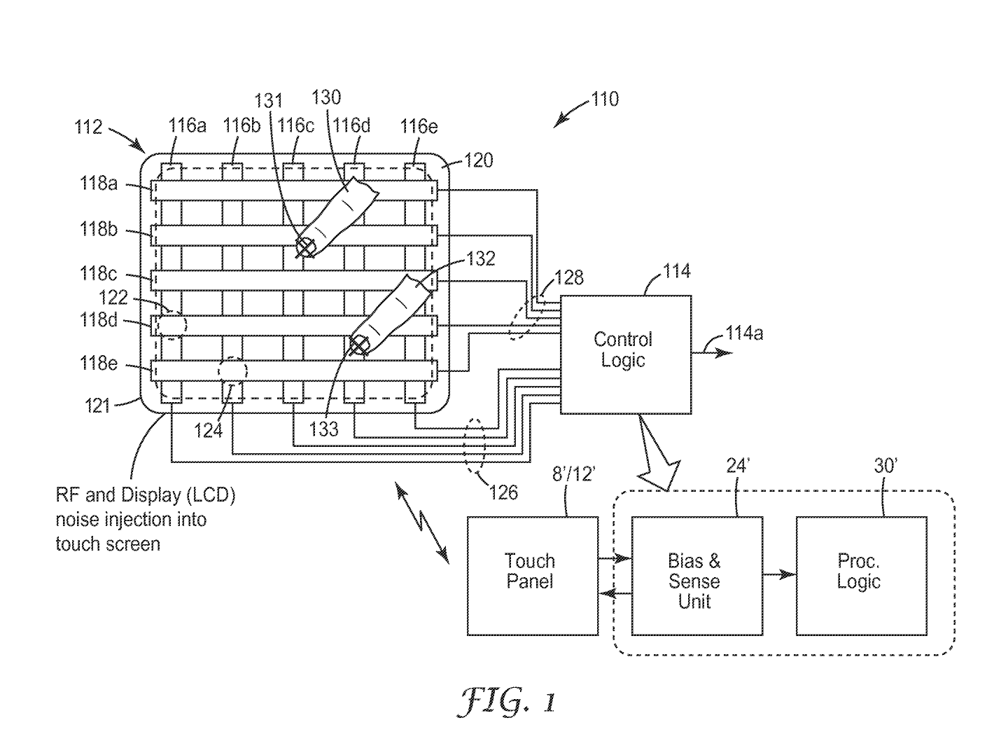

Referring now to the Figures, in FIG. 1 an exemplary touch device (e.g., touch sensor) 110 is shown. The device 110 includes a touch panel 112 connected to electronic circuitry, which for simplicity is grouped together into a single schematic box labeled 114 and referred to collectively as a controller which is implemented as (control) logic circuitry such as including analog-signal interface circuitry, a microcomputer, processor and/or programmable logic array.

The touch panel 112 is shown as having a 5×5 matrix of column electrodes 116a-e and row electrodes 118a-e, but other numbers of electrodes and other matrix sizes can also be used. For many applications, the touch panel 112 is exemplified as being transparent or semi-transparent to permit the user to view an object through the touch panel. Such applications include, for example, objects for the pixilated display of a computer, hand-held device, mobile phone, or other peripheral device. The boundary 120 represents the viewing area of the touch panel 112 and also preferably the viewing area of such a display. The boundary 121 represents the border area of the touch panel 112, which surrounds the boundary 120 of the viewing area of the touch panel 112. The border area 121 is typically at least somewhat opaque to hide electronic components from view.

The electrodes 116a-e, 118a-e are spatially distributed, from a plan view perspective, over the boundary 120. For ease of illustration the electrodes are shown to be wide and obtrusive, but in practice they may be relatively narrow and inconspicuous to the user. Further, the electrodes may be designed to have variable widths, e.g., an increased width in the form of a diamond- or other-shaped pad in the vicinity of the nodes of the matrix in order to increase the inter-electrode fringe field and thereby increase the effect of a touch on the electrode-to-electrode capacitive coupling. In exemplary embodiments, the electrodes may be composed of indium tin oxide (ITO) or other suitable electrically conductive materials. From a depth perspective, the column electrodes may lie in a different plane than the row electrodes (from the perspective of FIG. 1, the column electrodes 116a-e lie underneath the row electrodes 118a-e) such that no significant ohmic contact is made between column and row electrodes, and so that the only significant electrical coupling between a given column electrode and a given row electrode is capacitive coupling.

The matrix of electrodes typically lies beneath a cover glass, plastic film, or the like, so that the electrodes are protected from direct physical contact with a user's finger or other touch-related implement. An exposed surface of such a cover glass, film, or the like may be referred to as a touch surface and/or as a base substrate. Additionally, in display-type applications, a back shield (as an option) may be placed between the display and the touch panel 112. Such a back shield typically consists of a conductive ITO coating on a glass or film, and can be grounded or driven with a waveform that reduces signal coupling into touch panel 112 from external electrical interference sources. Other approaches to back shielding are known in the art. In general, a back shield reduces noise sensed by touch panel 112, which in some embodiments may provide improved touch sensitivity (e.g., ability to sense a lighter touch) and faster response time. Back shields are sometimes used in conjunction with other noise reduction approaches, including spacing apart touch panel 112 and a display, as noise strength from LCD displays, for example, rapidly decreases over distance.

The capacitive coupling between a given row and column electrode is primarily a function of the geometry of the electrodes in the region where the electrodes are closest together. Such regions correspond to the “nodes” of the electrode matrix, some of which are labeled in FIG. 1. For example, capacitive coupling between column electrode 116a and row electrode 118d occurs primarily at node 122, and capacitive coupling between column electrode 116b and row electrode 118e occurs primarily at node 124. The 5×5 matrix of FIG. 1 has such nodes, anyone of which can be addressed by controller 114 via appropriate selection of one of the control lines 126, which individually couple the respective column electrodes 116a-e to the controller, and appropriate selection of one of the control lines 128, which individually couple the respective row electrodes 118a-e to the controller.

When a finger 130 of a user or other touch implement comes into contact or near-contact with the touch surface of the device 110, as shown at touch location 131, the finger capacitively couples to the electrode matrix. The finger draws charge from the matrix, particularly from those electrodes lying closest to the touch location, and in doing so it changes the coupling capacitance between the electrodes corresponding to the nearest node(s). For example, the touch at touch location 131 lies nearest the node corresponding to electrodes 116c/118b. This change in coupling capacitance can be detected by controller 114 and interpreted as a touch at or near the 116a/118b node. Preferably, the controller is configured to rapidly detect the change in capacitance, if any, of all of the nodes of the matrix, and is capable of analyzing the magnitudes of capacitance changes for neighboring nodes so as to accurately determine a touch location lying between nodes by interpolation. Furthermore, the controller 114 advantageously is designed to detect multiple distinct touches applied to different portions of the touch device at the same time, or at overlapping times. Thus, for example, if another finger touches the touch surface of the device 110 at touch location 133 simultaneously with the touch of finger 130, or if the respective touches at least temporally overlap, the controller is preferably capable of detecting the positions 131, 133 of both such touches and providing such locations on a touch output 114a. The number of distinct simultaneous or temporally overlapping touches capable of being detected by controller 114 is preferably not limited to 2, e.g., it may be 3, 4, or greater than 60, depending on the size of the electrode matrix.

The controller 114 can employ a variety of circuit modules and components that enable it to rapidly determine the coupling capacitance at some or all of the nodes of the electrode matrix. For example, the controller preferably includes at least one signal generator or drive unit. The drive unit delivers a drive signal to one set of electrodes, referred to as drive electrodes. In the embodiment of FIG. 1, the column electrodes 116a-e may be used as drive electrodes, or the row electrodes 118a-e may be so used. The drive signal is preferably delivered to one drive electrode at a time, e.g., in a scanned sequence from a first to a last drive electrode. As each such electrode is driven, the controller monitors the other set of electrodes, referred to as receive (or sense) electrodes. The controller 114 may include one or more sense units coupled to all of the receive electrodes. For each drive signal that is delivered to each drive electrode, the sense units generate response signals for the plurality of receive electrodes. Preferably, the sense units are designed such that each response signal comprises a differentiated representation of the drive signal. For example, if the drive signal is represented by a function f(t) (e.g., representing a voltage as a function of time), then the response signal may be equal to, or provide an approximation of, a function g(t), where g(t)=d f(t)/dt. In other words, g(t) is the derivative with respect to time of the drive signal f(t). Depending on the design details of the circuitry used in the controller 114, the response signal may include signals such as: (1) g(t) alone; or (2) g(t) with a constant offset (g(t)+a); or (3) g(t) with a multiplicative scaling factor (b*g(t)), the scaling factor capable of being positive or negative, and capable of having a magnitude greater than 1, or less than 1 but greater than 0; or (4) combinations thereof. In any case, the amplitude of the response signal is advantageously related to the coupling capacitance between the drive electrode being driven and the particular receive electrode being monitored. The amplitude of g(t) is also proportional to the amplitude of the original function f(t), and if appropriate for the application the amplitude of g(t) can be determined for a given node using only a single pulse of a drive signal.

The controller may also include circuitry to identify and isolate the amplitude of the response signal. Exemplary circuit devices for this purpose may include one or more peak detectors, sample/hold buffer, time variable integrator and/or second stage integrator low-pass filter, the selection of which may depend on the nature of the drive signal and the corresponding response signal. The controller may also include one or more analog-to-digital converters (ADCs) to convert the analog amplitude to a digital format. One or more multiplexers may also be used to avoid unnecessary duplication of circuit elements. Of course, the controller also preferably includes one or more memory devices in which to store the measured amplitudes and associated parameters, and a microprocessor to perform the necessary calculations and control functions.

By measuring the amplitude of the response signal for each of the nodes in the electrode matrix, the controller can generate a matrix of measured values related to the coupling capacitances for each of the nodes of the electrode matrix. These measured values can be compared to a similar matrix of previously obtained reference values in order to determine which nodes, if any, have experienced a change in coupling capacitance due to the presence of a touch.

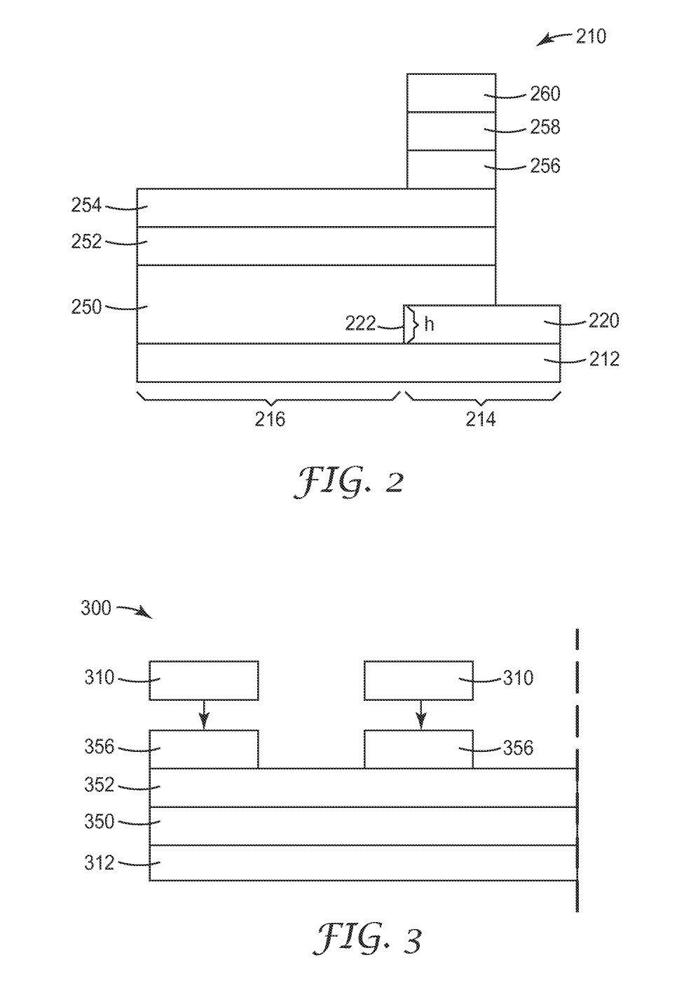

Referring to FIG. 2, a cross-sectional schematic of an exemplary multilayer stack 210 of a touch sensor according to the present disclosure is provided. The multilayer stack 210 includes a base substrate 212 that acts as a touch panel for a user. In most embodiments, the base substrate 212 is transparent for the user to view a display beneath the multilayer stack 210. Substrates (e.g., base substrates) for devices using the multilayer stack can include any type of substrate material for use in making a display or electronic device. The substrate can be rigid, for example by using glass or other materials. The substrate can also be curved or flexible, for example by using plastics or other materials. Substrates can be made using the following exemplary materials: glass; polyethylene terephthalate (PET); polyethylene napthalate (PEN); polycarbonate (PC); polyetheretherketone (PEEK); polyethersulphone (PES); polyarylate (PAR); polyimide (PI); poly(methyl methacrylate) (PMMA); polycyclic olefin (PCO); cellulose triacetate (TAC); and polyurethane (PU).

Other suitable materials for the substrate include chlorotrifluoroethylene-vinylidene fluoride copolymer (CTFE/VDF), ethylene-chlorotrifluoroethylene copolymer (ECTFE), ethylene-tetrafluoroethylene copolymer (ETFE), fluorinated ethylene-propylene copolymer (FEP), polychlorotrifluoroethylene (PCTFE), perfluoroalkyl-tetrafluoroethylene copolymer (PFA), polytetrafluoroethyloene (PTFE), polyvinylidene fluoride (PVDF), polyvinyl fluoride (PVF), tetrafluoroethylene-hexafluoropropylene copolymer (TFE/HFP), tetrafluoroethylene-hexafluoropropylene-vinylidene fluoride terpolymer (THV), polychlorotrifluoroethylene (PCTFE), hexafluoropropylene-vinylidene fluoride copolymer (HFP/VDF), tetrafluoroethylene-propylene copolymer (TFE/P), and tetrafluoroethylene-perfluoromethylether copolymer (TFE/PFMe).

Other suitable substrates include barrier films and ultrabarrier films. An example of a barrier film is described in U.S. Pat. No. 7,468,211, which is incorporated herein by reference as if fully set forth. Ultrabarrier films include multilayer films made, for example, by vacuum deposition of two inorganic dielectric materials sequentially in a multitude of layers on a glass or other suitable substrate, or alternating layers of inorganic materials and organic polymers, as described in U.S. Pat. Nos. 5,440,446; 5,877,895; and 6,010,751, all of which are incorporated herein by reference as if fully set forth.

Referring back to FIG. 2, the multilayer stack 210 includes a border layer 220 disposed in and covering the border area 214, but not the viewing area 216 of the multilayer stack 210. The border layer 220 is preferably optically opaque to conceal electronic components present outside the perimeter of the viewing area 216 of the multilayer stack 210. The optical density of an optically opaque border layer is at least 2. Such electronic components include printed conductors 256 and flexible printed circuits 260, which are not optically transparent components. Typically, at least portions of the border area are adapted to be touch insensitive, and in some aspects the entire border area is adapted to be touch insensitive. The border layer 220 defines a step 222 proximate to and extending along a perimeter of the viewing area 216 and having a step height h of at least 5 microns (μm). In certain embodiments, the step 222 has a step height h of at least 7 μm, or at least 9 μm, or at least 11 μm, or at least 13 μm, or at least 15 μm, or at least 17 μm, or even at least 19 μm, and a step height h of up to 20 μm, or up to 18 μm, or up to 16 μm, or up to 14 μm, or up to 12 μm, or up to 10 μm, or even up to 8 μm.

The multilayer stack 210 further includes an optically transparent adhesive layer 250 disposed on the base substrate 212 and the border layer 220 and covering the viewing area 216 and the border area 214 of the multilayer stack 210. In certain embodiments, the adhesive layer is at least 30 microns (μm) thick, or at least 35 μm thick, or at least 40 μm thick, or even at least 45 μm thick, and up to 50 μm thick. A maximum height variation of a major surface of the optically transparent adhesive layer 250 away from the viewing area in a region corresponds to the step being less than the step height. Accordingly, the optically transparent adhesive material at least partially conforms to the step 222. Any gap between the optically transparent adhesive layer 250 and the intersection of the border layer 220 and the base substrate 212 preferably is minimized, usually by employing an adhesive layer at least 30 μm thick.

An advantage of certain embodiments of the touch sensor according to the present disclosure is that any void or bubble formed between the base substrate 212, the optically opaque border layer 220, and the optically transparent adhesive layer 250 at the step 222 is substantially unresolvable by a human eye at a normal viewing distance. The term “normal viewing distance” as used herein refers to a distance of about 1 to 2 feet, which is a typical distance from which a user would view a touch panel. In certain embodiments, from a top view of the multilayer stack, any void or bubble formed between the base substrate, the optically opaque border layer, and the optically transparent adhesive layer at the step has a maximum dimension of 20 millimeters (mm) or of 15 mm along a direction parallel to the perimeter of the viewing area, and a maximum dimension of 1.5 mm, 1 mm, or 0.5 mm along a direction perpendicular to the perimeter of the viewing area.

A suitable optically transparent adhesive material includes, for example, a curable adhesive composition containing a) a first oligomer comprising (meth)acrylate ester monomer units, hydroxyl-functional monomer units, and monomer units having polymerizable groups; b) a second component comprising C₂-C₄ alkylene oxide repeat units and polymerizable terminal groups, and c) a diluent monomer component. The polymerizable groups of the first oligomer are typically free-radically photopolymerizable groups, such as pendent (meth)acrylate groups or terminal aryl ketone photoinitiator groups. Such curable adhesive compositions are described in PCT Application No. PCT/US2013/071883, which is incorporated herein by reference as if fully set forth. Additional suitable optically transparent adhesive materials include acrylic adhesives, for instance acrylic adhesives commercially available from 3M Company (St. Paul, Minn.), such as 3M 8142-KCL. Another suitable optically transparent adhesive material includes polycarbonate resin with a transmission factor of not less than 90%. Other typical suitable optically transparent adhesive materials are known to those of skill in the art. In certain embodiments, a storage modulus of the optically transparent adhesive layer is not greater than about 1.75×10⁵.

Referring again to FIG. 2, in certain embodiments of the present disclosure, the multilayer stack 210 includes an optically transparent dielectric substrate 252 disposed on the optically transparent adhesive. Suitable nonconducting substrates 252 include the materials disclosed above as suitable base substrate materials.

The multilayer stack 210 further includes a plurality of discrete spaced apart optically transparent electrodes 254 disposed on the adhesive layer 250 (or directly on the dielectric substrate 252), each electrode 254 extending across the step 222 of the optically opaque border layer. Preferably, each electrode 254 extends across substantially the entire viewing area 216. The shape of each electrode is not particularly limited. For example, in an embodiment each optically transparent electrode includes a plurality of alternating wider sense electrodes and narrower connecting bars. Each wider sense electrode is optionally diamond shaped.

Suitable transparent conducting oxides (TCOs) for the optically transparent electrodes include the following exemplary materials: ITO (Indium tin oxide); tin oxides; cadmium oxides (CdSn₂O₄, CdGa₂O₄, CdIn₂O₄, CdSb₂O₆, CdGeO₄); indium oxides (In₂O₃, Ga, GaInO₃ (Sn, Ge), (GaIn)₂O₃); zinc oxides (ZnO(Al), ZnO(Ga), ZnSnO₃, Zn₂SnO₄, Zn₂In₂O₅, Zn₃In₂O₆); and magnesium oxides (MgIn₂O₄, MgIn₂O₄—Zn₂In₂O₅). The optically transparent electrodes optionally comprise a solution coated or electro-deposited conductive polymer. The electrode can also be a vapor deposited transparent conductor. Conducting polymers include the following exemplary materials: polyaniline; polypyrrole; polythiophene; and PEDOT/PSS (poly(3,4 ethylenedioxythiophene)/polystyrenesulfonic acid). In yet another embodiment, the intervening layer comprises conductive particles dispersed in a binder. The conductive particles in binder provide conductive pathways between the conductive layers of TCO or semitransparent conductive oxide, thus forming a multilayer electrode.

The multilayer stack 210 comprises a plurality of discrete spaced apart electrically conductive pads disposed in the border, but not the viewing, area of the multilayer stack. Each conductive pad is disposed on and makes physical contact with a different corresponding electrode over a contact region.

Exemplary conductive pads comprise a conductive material, such as carbon or a metal. Exemplary metals include for example and without limitation, silver, gold, copper, aluminum, zinc, nickel, and chrome, and most preferably silver. In certain embodiments, the electrically conductive pads are printed on the multilayer stack, for instance by ink jet printing, screen printing, flexographic printing, and the like. The electrically conductive pads are optionally thermally cured or photonically cured on the corresponding electrodes.

A suitable thickness of the conductive pads is at least 0.8 μm, at least 1 μm, at least 2 μm, at least 4 μm, at least 6 μm, at least 8 μm, at least 10 μm, at least 12 μm, at least 14 μm, at least 16 μm, or even at least 18 μm, and up to 20 μm, or up to 17 μm, or up to 15 μm, or up to 13 μm, or up to 11 μm, or up to 9 μm, or up to 7 μm, or up to 5 μm, or up to 3 μm. The electrically conductive pads are disposed in the border area of the multilayer stack in part because they are not transparent. Preferably, the conductive pads are printed on corresponding electrodes, for instance, each electrically conductive pad may be disposed on a sense electrode of the corresponding electrode.

As noted above, challenges are presented when employing a rigid, brittle transparent conductor, a flexible substrate, a layer of optically clear adhesive to attach the non-conducting side of the substrate to a display device, and a z-axis conductive adhesive and a flexible printed circuit to attach the conducting side of the substrate to an electronic device. A mismatch in the material properties of such layers can cause high manufacturing yield loss during the flexible printed circuit attachment process step, such as due to compressive stress and temperature requirements. A discrete electrode which is constructed by printing and curing conductive ink onto a thin, rigid, and brittle optically transparent electrode; however, can conduct electricity after being subjected to a wide range of pressures and temperatures. The aforementioned electrode can advantageously minimize the occurrence of cracking in the optically transparent electrode (e.g., ITO layer) at standard process pressures by reducing the stress on the electrode, as well as providing electrical conductivity across any cracks that do form.

Referring again to FIG. 2, the multilayer stack 210 further comprises a z-axis adhesive (or anisotropic conductive adhesive) 258 for physically and electrically connecting the conductive pads to a flexible printed circuit 260. A z-axis conductive adhesive provides for electrical connections through the thickness of the adhesive layer and substantially prevents electrical connections in the plane of the adhesive layer. Exemplary conductive adhesives for use in a multilayer stack 210 include 5303R Z-Axis Adhesive Film, 7303 Z-Axis Adhesive Film, and 7371-20 Anisotropic Conductive Film, each of which is available from 3M Bonding Systems Division (3M Company (St. Paul, Minn.)). The flexible printed circuit electrically connects the multilayer stack 210 to the control logic 114.

As noted above, under the compressive stress required to compress or embed the z-axis adhesive, the optically transparent adhesive generally permanently deforms plastically due to creep, and the temperature required for curing the z-axis adhesive increases the severity of this deformation. As the thin film conductor is rigid and brittle, it cannot match the deformation while maintaining the desired material and electrical properties. Hence, the thin film conductor fractures if the yield stress is reached, and electricity cannot efficiently be conducted.

Due to the processing conditions required to construct touch sensors having a multilayer stack, at least one electrode 254 is typically cracked in the contact region between the electrode 254 and the pad 256 corresponding to the electrode, resulting in the electrode being electrically non-continuous across the crack. For such cracked electrodes, the pad provides electrical continuity across the crack. In certain embodiments, the optically transparent electrode comprises a crack near the step resulting in the electrode being electrically non-continuous across the crack, and the electrically conductive pad provides electrical continuity across the crack.

The following items are exemplary embodiments according to aspects of the present invention.

Item 1 is a multilayer stack for use in a touch sensor and having a border area surrounding a viewing area, the viewing area adapted to face a viewer and be touch sensitive, the multilayer stack including:
a base substrate covering the viewing and border areas of the multilayer stack;
an optically opaque border layer disposed in and covering the border, but not the viewing, area of the multilayer stack, the border layer defining a step proximate to and extending along a perimeter of the viewing area and having a step height of at least 5 microns;
an optically transparent adhesive layer disposed on the base substrate and the border layer and covering the viewing and border areas of the multilayer stack, a maximum height variation of a major surface of the optically transparent adhesive layer away from the viewing area in a region corresponding to the step being less than the step height;
a plurality of discrete spaced apart optically transparent electrodes disposed on the adhesive layer, each electrode extending across the step; and
a plurality of discrete spaced apart electrically conductive pads disposed in the border, but not the viewing, area of the multilayer stack, each pad being disposed on and making physical contact with a different corresponding electrode over a contact region.

Item 2 is the multilayer stack of item 1, wherein the adhesive layer is at least 30 microns thick.

Item 3 is the multilayer stack of item 1, wherein the adhesive layer is at least 40 microns thick.

Item 4 is the multilayer stack of item 1, wherein at least portions of the border area are adapted to be touch insensitive.

Item 5 is the multilayer stack of item 1, wherein any void or bubble formed between the base substrate, the optically opaque border layer and the optically transparent adhesive layer at the step is substantially unresolvable by a human eye at a normal viewing distance.

Item 6 is the multilayer stack of item 1, wherein each electrode extends across substantially the entire viewing area.

Item 7 is the multilayer stack of item 1, wherein at least one electrode is cracked in the contact region between the electrode and the pad corresponding to the electrode, resulting in the electrode being electrically non-continuous across the crack, the pad providing electrical continuity across the crack.

Item 8 is the multilayer stack of item 1, wherein a storage modulus of the optically transparent adhesive layer is not greater than about 1.75×10⁵.

Item 9 is the multilayer stack of item 1, wherein an optical density of the optically opaque border layer is at least 2.

Item 10 is the multilayer stack of item 1, wherein the step height is at least 7 microns.

Item 11 is the multilayer stack of item 1, wherein the step height is at least 9 microns.

Item 12 is the multilayer stack of item 1, wherein the step height is at least 11 microns.

Item 13 is the multilayer stack of item 1, wherein from a top view of the multilayer stack, any void or bubble formed between the base substrate, the optically opaque border layer and the optically transparent adhesive layer at the step has a maximum dimension of 20 mm along a direction parallel to the perimeter of the viewing area and a maximum dimension of 1.5 mm along a direction perpendicular to the perimeter of the viewing area.

Item 14 is the multilayer stack of item 1, wherein from a top view of the multilayer stack, any void or bubble formed between the base substrate, the optically opaque border layer and the optically transparent adhesive layer at the step has a maximum dimension of 20 mm along a direction parallel to the perimeter of the viewing area and a maximum dimension of 1 mm along a direction perpendicular to the perimeter of the viewing area.

Item 15 is the multilayer stack of item 1, wherein from a top view of the multilayer stack, any void or bubble formed between the base substrate, the optically opaque border layer and the optically transparent adhesive layer at the step has a maximum dimension of 20 mm along a direction parallel to the perimeter of the viewing area and a maximum dimension of 0.5 mm along a direction perpendicular to the perimeter of the viewing area.

Item 16 is the multilayer stack of item 1, wherein from a top view of the multilayer stack, any void or bubble formed between the base substrate, the optically opaque border layer and the optically transparent adhesive layer at the step has a maximum dimension of 15 mm along a direction parallel to the perimeter of the viewing area and a maximum dimension of 1.5 mm along a direction perpendicular to the perimeter of the viewing area.

Item 17 is the multilayer stack of item 1, wherein from a top view of the multilayer stack, any void or bubble formed between the base substrate, the optically opaque border layer and the optically transparent adhesive layer at the step has a maximum dimension of 15 mm along a direction parallel to the perimeter of the viewing area and a maximum dimension of 1 mm along a direction perpendicular to the perimeter of the viewing area.

Item 18 is the multilayer stack of item 1, wherein from a top view of the multilayer stack, any void or bubble formed between the base substrate, the optically opaque border layer and the optically transparent adhesive layer at the step has a maximum dimension of 15 mm along a direction parallel to the perimeter of the viewing area and a maximum dimension of 0.5 mm along a direction perpendicular to the perimeter of the viewing area.

Item 19 is the multilayer stack of item 1, wherein the conductive pads are printed on corresponding electrodes.

Item 20 is the multilayer stack of item 1, wherein each optically transparent electrode includes a plurality of alternating wider sense electrodes and narrower connecting bars.

Item 21 is the multilayer stack of item 20, wherein each wider sense electrode is diamond shaped.

Item 22 is the multilayer stack of item 20, wherein each electrically conductive pad is disposed on a sense electrode of the corresponding electrode.

Item 23 is the multilayer stack of item 1, wherein each electrically conductive pad comprises silver.

Item 24 is a multilayer stack for use in a touch sensor and having a border area surrounding a viewing area, the viewing area adapted to face a viewer and be touch sensitive, the multilayer stack including:
a base substrate covering the viewing and border areas of the multilayer stack;
an optically opaque border layer disposed in and covering the border, but not the viewing, area of the multilayer stack, the border layer defining a step proximate to and extending along a perimeter of the viewing area and having a step height of at least 5 microns;
an optically transparent adhesive layer disposed on the base substrate and the border layer and covering the viewing and border areas of the multilayer stack,
a plurality of discrete spaced apart optically transparent electrodes disposed on the adhesive layer, each electrode extending across the step; and
a plurality of discrete spaced apart electrically conductive pads disposed in the border, but not the viewing, area of the multilayer stack, each pad being disposed on and making physical contact with a different corresponding electrode over a contact region, wherein any void or bubble formed between the base substrate, the optically opaque border layer and the optically transparent adhesive layer at the step is substantially unresolvable by a human eye viewing the multilayer stack at a normal viewing distance.

Item 25 is the multilayer stack of item 24, wherein the adhesive layer substantially planarizes the step such that a major surface of the adhesive layer away from the base substrate is substantially planar in a region corresponding to the step.

Item 26 is the multilayer stack of item 24, wherein the adhesive layer is at least 30 microns thick.

Item 27 is the multilayer stack of item 24, wherein the adhesive layer is at least 40 microns thick.

Item 28 is the multilayer stack of item 24, wherein at least portions of the border area are adapted to be touch insensitive.

Item 29 is the multilayer stack of item 24, wherein each electrode extends across substantially the entire viewing area.

Item 30 is the multilayer stack of item 24, wherein at least one electrode is cracked in the contact region between the electrode and the pad corresponding to the electrode, resulting in the electrode being electrically non-continuous across the crack, the pad providing electrical continuity across the crack.

Item 31 is the multilayer stack of item 24, wherein a storage modulus of the optically transparent adhesive layer is not greater than about 1.75×10⁵.

Item 32 is the multilayer stack of item 24, wherein an optical density of the optically opaque border layer is at least 2.

Item 33 is the multilayer stack of item 24, wherein the step height is at least 7 microns.

Item 34 is the multilayer stack of item 24, wherein the step height is at least 9 microns.

Item 35 is the multilayer stack of item 24, wherein the step height is at least 11 microns.

Item 36 is the multilayer stack of item 24, wherein from a top view of the multilayer stack, any void or bubble formed between the base substrate, the optically opaque border layer and the optically transparent adhesive layer at the step has a maximum dimension of 20 mm along a direction parallel to the perimeter of the viewing area and a maximum dimension of 1.5 mm along a direction perpendicular to the perimeter of the viewing area.

Item 37 is the multilayer stack of item 24, wherein from a top view of the multilayer stack, any void or bubble formed between the base substrate, the optically opaque border layer and the optically transparent adhesive layer at the step has a maximum dimension of 20 mm along a direction parallel to the perimeter of the viewing area and a maximum dimension of 1 mm along a direction perpendicular to the perimeter of the viewing area.

Item 38 is the multilayer stack of item 24, wherein from a top view of the multilayer stack, any void or bubble formed between the base substrate, the optically opaque border layer and the optically transparent adhesive layer at the step has a maximum dimension of 20 mm along a direction parallel to the perimeter of the viewing area and a maximum dimension of 0.5 mm along a direction perpendicular to the perimeter of the viewing area.

Item 39 is the multilayer stack of item 24, wherein from a top view of the multilayer stack, any void or bubble formed between the base substrate, the optically opaque border layer and the optically transparent adhesive layer at the step has a maximum dimension of 15 mm along a direction parallel to the perimeter of the viewing area and a maximum dimension of 1.5 mm along a direction perpendicular to the perimeter of the viewing area.

Item 40 is the multilayer stack of item 24, wherein from a top view of the multilayer stack, any void or bubble formed between the base substrate, the optically opaque border layer and the optically transparent adhesive layer at the step has a maximum dimension of 15 mm along a direction parallel to the perimeter of the viewing area and a maximum dimension of 1 mm along a direction perpendicular to the perimeter of the viewing area.

Item 41 is the multilayer stack of item 24, wherein from a top view of the multilayer stack, any void or bubble formed between the base substrate, the optically opaque border layer and the optically transparent adhesive layer at the step has a maximum dimension of 15 mm along a direction parallel to the perimeter of the viewing area and a maximum dimension of 0.5 mm along a direction perpendicular to the perimeter of the viewing area.

Item 42 is the multilayer stack of item 24, wherein the conductive pads are printed on corresponding electrodes.

Item 43 is the multilayer stack of item 24, wherein each optically transparent electrode includes a plurality of alternating wider sense electrodes and narrower connecting bars.

Item 44 is the multilayer stack of item 43, wherein each wider sense electrode is diamond shaped.

Item 45 is the multilayer stack of item 43, wherein each electrically conductive pad is disposed on a sense electrode of the corresponding electrode.

Item 46 is the multilayer stack of item 24, wherein each electrically conductive pad comprises silver.

Item 47 is a touch sensor having a touch sensitive area surrounded by a border area, a vertical step separating the border area from the touch sensitive area and extending along a perimeter of the touch sensitive area, the step having a step height of at least 5 microns, an optically transparent adhesive layer disposed on and covering the touch sensitive and border areas and having a minimum thickness of at least 30 microns, an optically transparent electrode disposed on the optically transparent adhesive layer in the border area and extending across the vertical step, an electrically conductive pad disposed on the electrode in the border area.

Item 48 is the touch sensor of item 47, wherein the optically transparent electrode comprises a crack near the step resulting in the electrode being electrically non-continuous across the crack, the electrically conductive pad providing electrical continuity across the crack

Item 49 is the touch sensor of item 47, wherein a maximum height variation of a major surface of the optically transparent adhesive layer away from the touch sensitive area in a region corresponding to the vertical step is less than the step height.

Item 50 is the touch sensor of item 47, wherein the optically transparent electrode extends across substantially the entire viewing area.

Item 51 is the touch sensor of item 47 further comprising a flexible printed circuit electrically connected to the conductive pads via a conductive adhesive.

Item 52 is the touch sensor of item 47, wherein the adhesive layer is at least 40 microns thick.

Item 53 is the touch sensor of item 47, wherein at least portions of the border area are adapted to be touch insensitive.

Item 54 is the touch sensor of item 47, wherein a storage modulus of the optically transparent adhesive layer is not greater than about 1.75×10⁵.

Item 55 is the touch sensor of item 47, wherein the step height is at least 7 microns.

Item 56 is the touch sensor of item 47, wherein the step height is at least 9 microns.

Item 57 is the touch sensor of item 47, wherein the step height is at least 11 microns.

Item 58 is the touch sensor of item 47, wherein the optically transparent electrode includes a plurality of alternating wider sense electrodes and narrower connecting bars.

Item 59 is the touch sensor of item 58, wherein each wider sense electrode is diamond shaped.

Item 60 is the touch sensor of item 58, wherein each electrically conductive pad is disposed on a sense electrode of the corresponding electrode.

Item 61 is the touch sensor of item 47, wherein each electrically conductive pad comprises silver.

Item 62 is a method of making a multilayer stack for use in a touch sensor and having a border area surrounding a viewing area, the viewing area adapted to face a viewer and be touch sensitive, the method including:
covering the viewing and border areas of the multilayer stack with a base substrate;
disposing an optically opaque border layer in and covering the border, but not the viewing, area of the multilayer stack, the border layer defining a step proximate to and extending along a perimeter of the viewing area and having a step height of at least 5 microns;
disposing an optically transparent adhesive layer on the base substrate and the border layer and covering the viewing and border areas of the multilayer stack, a maximum height variation of a major surface of the optically transparent adhesive layer away from the viewing area in a region corresponding to the step being less than the step height;
disposing a plurality of discrete spaced apart optically transparent electrodes on the adhesive layer, each electrode extending across the step; and
disposing a plurality of discrete spaced apart electrically conductive pads in the border, but not the viewing, area of the multilayer stack, each pad being disposed on and making physical contact with a different corresponding electrode over a contact region.

Item 63 is the method of item 62, wherein the adhesive layer is at least 30 microns thick.

Item 64 is the method of item 62, wherein the adhesive layer is at least 40 microns thick.

Item 65 is the method of item 62, wherein at least portions of the border area are adapted to be touch insensitive.

Item 66 is the method of item 62, wherein any void or bubble formed between the base substrate, the optically opaque border layer and the optically transparent adhesive layer at the step is substantially unresolvable by a human eye at a normal viewing distance.

Item 67 is the method of item 62, wherein each electrode extends across substantially the entire viewing area.

Item 68 is the method of item 62, wherein at least one electrode is cracked in the contact region between the electrode and the pad corresponding to the electrode, resulting in the electrode being electrically non-continuous across the crack, the pad providing electrical continuity across the crack.

Item 69 is the method of item 62, wherein a storage modulus of the optically transparent adhesive layer is not greater than about 1.75×10⁵.

Item 70 is the method of item 62, wherein an optical density of the optically opaque border layer is at least 2.

Item 71 is the method of item 62, wherein the step height is at least 7 microns.

Item 72 is the method of item 62, wherein the step height is at least 9 microns.

Item 73 is the method of item 62, wherein the step height is at least 11 microns.

Item 74 is the method of item 62, wherein from a top view of the multilayer stack, any void or bubble formed between the base substrate, the optically opaque border layer and the optically transparent adhesive layer at the step has a maximum dimension of 20 mm along a direction parallel to the perimeter of the viewing area and a maximum dimension of 1.5 mm along a direction perpendicular to the perimeter of the viewing area.

Item 75 is the method of item 62, wherein from a top view of the multilayer stack, any void or bubble formed between the base substrate, the optically opaque border layer and the optically transparent adhesive layer at the step has a maximum dimension of 20 mm along a direction parallel to the perimeter of the viewing area and a maximum dimension of 1 mm along a direction perpendicular to the perimeter of the viewing area.

Item 76 is the method of item 62, wherein from a top view of the multilayer stack, any void or bubble formed between the base substrate, the optically opaque border layer and the optically transparent adhesive layer at the step has a maximum dimension of 20 mm along a direction parallel to the perimeter of the viewing area and a maximum dimension of 0.5 mm along a direction perpendicular to the perimeter of the viewing area.

Item 77 is the method of item 62, wherein from a top view of the multilayer stack, any void or bubble formed between the base substrate, the optically opaque border layer and the optically transparent adhesive layer at the step has a maximum dimension of 15 mm along a direction parallel to the perimeter of the viewing area and a maximum dimension of 1.5 mm along a direction perpendicular to the perimeter of the viewing area.

Item 78 is the method of item 62, wherein from a top view of the multilayer stack, any void or bubble formed between the base substrate, the optically opaque border layer and the optically transparent adhesive layer at the step has a maximum dimension of 15 mm along a direction parallel to the perimeter of the viewing area and a maximum dimension of 1 mm along a direction perpendicular to the perimeter of the viewing area.

Item 79 is the method of item 62, wherein from a top view of the multilayer stack, any void or bubble formed between the base substrate, the optically opaque border layer and the optically transparent adhesive layer at the step has a maximum dimension of 15 mm along a direction parallel to the perimeter of the viewing area and a maximum dimension of 0.5 mm along a direction perpendicular to the perimeter of the viewing area.

Item 80 is the method of item 62, wherein the conductive pads are printed on corresponding electrodes.

Item 81 is the method of item 62, wherein each optically transparent electrode includes a plurality of alternating wider sense electrodes and narrower connecting bars.

Item 82 is the method of item 62, wherein each wider sense electrode is diamond shaped.

Item 83 is the method of item 62, wherein each electrically conductive pad is disposed on a sense electrode of the corresponding electrode.

Item 84 is the method of item 62, wherein each electrically conductive pad comprises silver.

Item 85 is the method of item 62, wherein each electrically conductive pad is printed on the corresponding electrode.

Item 86 is the method of item 62, wherein each electrically conductive pad is thermally cured.

Item 87 is the method of item 62, wherein each electrically conductive pad is photonically cured.

### EXAMPLES

### Example 1

### Ink Jetted Conductive Patterns

Carbon and silver conductive inks were evaluated for feasibility of ink jet printability on touch sensors. The conductive ink materials are as listed below in Table 1.

TABLE 1

| | Part | Conductor | Conductor |
|---|---|---|---|
| Manufacturer | Number | Material | Loading |
| Methode Electronics, | 3800 | Carbon (C) | 6% by weight |
| Inc. (Chicago, IL) | | | |
| Sun Chemical | U7553 | Silver (Ag) | 20% by weight |
| (Minneapolis, MN) | | | |

The ink was jetted onto touch sensor stacks, and a cross-section of the touch sensor stack, not to scale, is shown in FIG. 3. The sensor stack 300 included a cover glass 312, an optically transparent adhesive 350, a PET substrate 352, conductive layers 356 consisting of ITO/SiO₂, and the conductive ink 310 jetted onto the conductive layers 356 in order to form discrete electrodes.

The settings for the printing on a Dimatix DMP 2800 printer (FUJIFILM Dimatix, Inc. (Santa Clara, Calif.)) were as shown in Table 2 below.

TABLE 2

| | | | | Meniscus |
|---|---|---|---|---|
| Part | | Drive | | Pressure |
| Number | Temperature | Voltage | Waveform (kV) | (inches H₂O) |
| 3800 | 31° C. | 20.6 V | Integrity 3800 5 kV | 4 |
| U7553 | 28.8° C. | 22.6 V | Dimatix MF 5 kV | 5 |

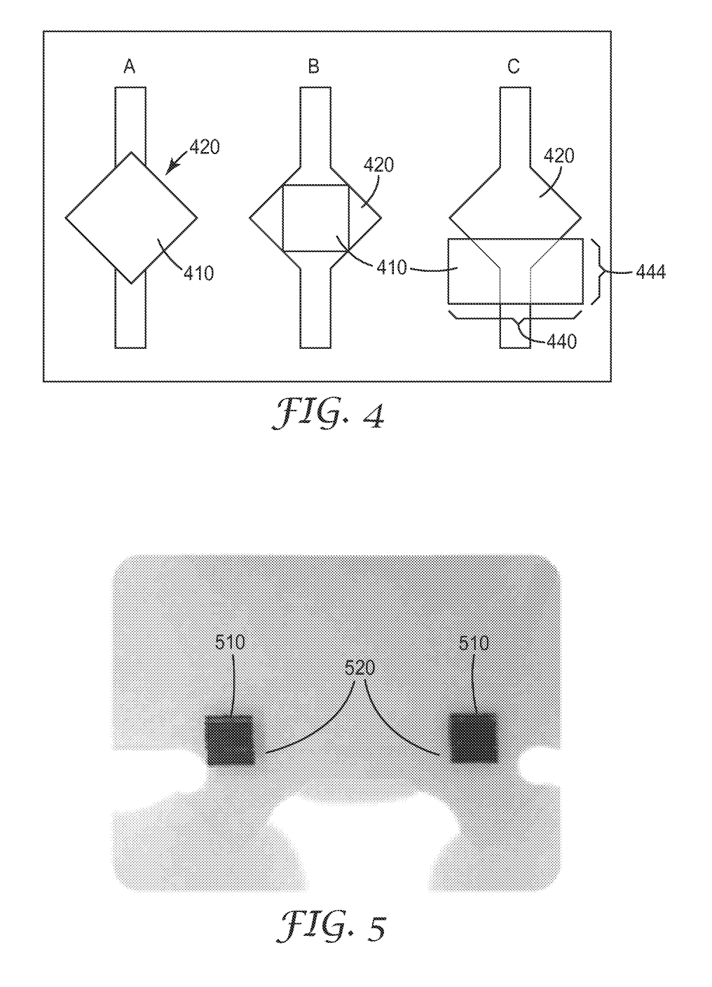

The conductive inks were printed in three different patterns, as depicted in FIG. 4 as top view schematics. In pattern A, the conductive ink 410 was printed over the entire ITO diamond 420, line to line. In pattern B, the conductive ink 410 was printed over the ITO diamond 420 (and was slightly larger than the copper flexible printed circuit pad which would be applied later during assembly). In pattern C, the conductive ink 410 was printed to a length 440 equivalent to the greatest width of the ITO trace 420 and to a conductive ink print width 444 slightly larger than the copper flexible printed circuit pad which would be applied later during assembly.

Observations were recorded on how the ink wetted out onto the sensor stack. In particular, characteristics observed included if the ink could hold its designated shape and if the ink could be printed by the ink jet head. When each type of ink was jetted onto the ITO regions, each was printed successfully and held its intended shape. For example, referring to FIG. 5, a photo is provided of 3800 (carbon) ink 510 jetted onto the ITO diamonds 520. Moreover, the U7553 (silver) ink wet out well across the ITO, PET, and the transition between the two (not shown). The only time U7553 ink bleeding occurred was when the shape was printed without spacing between the ink and an adjacent ridge.

### Example 2

### Conductivity of Ink Jetted Conductive Patterns

Methods of curing the carbon and silver conductive inks were evaluated after the conductive inks were jetted to form electrodes. Estimated sheet resistance and thickness of the printed conductive inks are shown in Table 3 below.

TABLE 3

| | | Estimated Sheet | Estimated |
|---|---|---|---|
| | Part | Resistance | Thickness at |
| Manufacturer | Number | (Ω/square) | 1270 dpi (μm) |
| Methode Electronics, | 3800 | 5,000-20,000 | 0.63 |
| Inc. (Chicago, IL) | | | |
| Sun Chemical | U7553 | 0.228 | 0.8 |
| (Minneapolis, MN) | | | |

Two batches of carbon ink were thermally cured in an industrial oven for 1 minute at temperatures between 60 and 100° C. (Alternatively, an IR light could also be used to photonically cure carbon ink.)

Two methods of curing were used for the printed silver electrodes; namely, thermal and pulsed light. Thermal curing was completed in an industrial oven for 30 minutes at 115° C. Photonic curing was completed by using a Sinteron 2000 R&D system available from Xenon Corporation (Wilmington, Mass.). The settings used for the photonic curing are shown in Table 4 below.

TABLE 4

| | Pulse | | Lamp | Lamp |
|---|---|---|---|---|
| Number of | Duration | Voltage | Energy | Spectra |
| Pulses | (μsec) | (kV) | (J) | (nm) |
| 3 | 500 | 3.2 | 600 | 370-1000 |

Each process was evaluated both qualitatively and quantitatively. Initial qualitative observations were recorded after the electrodes were cured, including whether or not the energy applied was adequate to cure the ink and the quality of the appearance of the cured electrode. Each type of ink and each type of cure was qualitatively evaluated for electrode cohesion and adhesion to adjacent layers. A flexible printed circuit was hot bar bonded to the electrode followed by a manual peel. The carbon ink exhibited a matte finish after thermal curing. Both thermal and photonic sintering was investigated on the silver ink. The electrodes that were thermally sintered exhibited a shiny finish, whereas the photonically sintered electrodes had a matte finish.

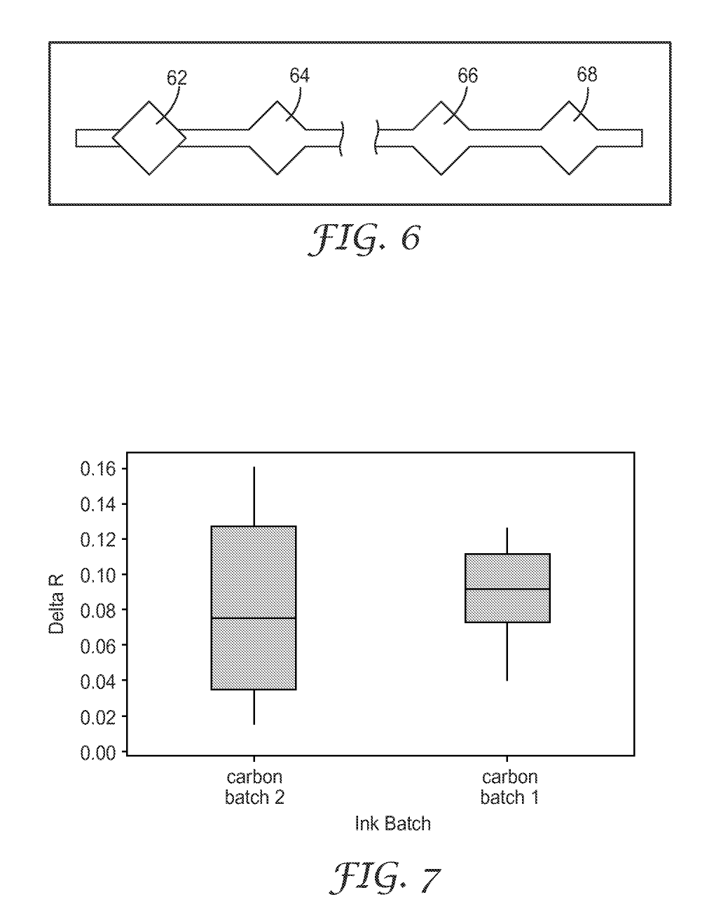

Referring to FIG. 6, the cured electrodes were quantitatively evaluated for line resistance from the electrode 62 to the seventeenth ITO diamond 66, including through the second ITO diamond 64 and the third through sixteenth ITO diamonds (not shown). The line resistance was also measured from the second ITO diamond 64 through the eighteenth ITO diamond 68 as a control. The difference between the two measurements was calculated and was the line resistance added by the cured conductive ink. This measurement was completed on ten separate traces for each type of ink and each type of cure.

The line resistance increase of the carbon ink is shown in FIG. 7. The line resistance was minimal and not considered a concern when evaluating feasibility of the carbon 3800 ink. Both the thermally cured and photonically cured carbon ink exhibited good adhesion to the PET, ITO, and anisotropic conductive film. During removal of the flexible printed circuit, a cohesive failure of the anisotropic conductive film occurred, which indicated that the carbon electrode would not be the weakest link in the layer construction.

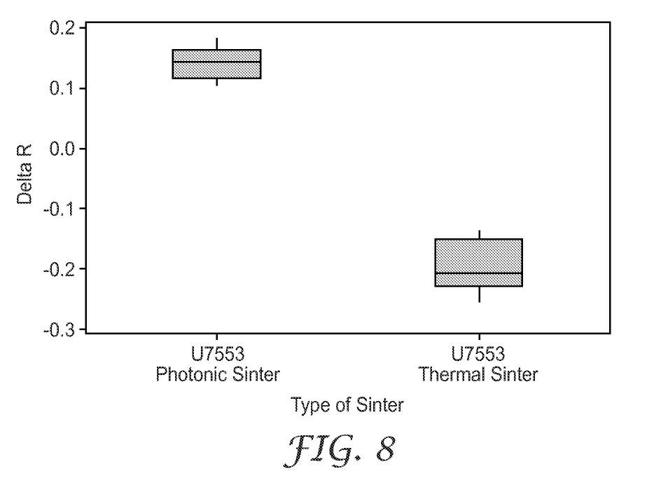

The line resistance increase of the silver ink is shown in FIG. 8. The 0.1-0.2 KΩ increase in line resistance of the photonically sintered samples was minimal and not considered a concern when evaluating feasibility. The line resistance of the thermally sintered samples was exceptionally lower than the control. The silver exhibited a lower resistance than the ITO when thermally sintered and provided a path of least resistance for the electricity to flow along. These resistance measurements indicated that the Ag particles sintered together very well and created a good conductor. The thermally sintered silver electrode exhibited an adhesive failure to the ITO. In the areas where the silver was thermally cured to the PET substrate only, there was a cohesive failure of the anisotropic conductive film. These observations indicated that thermally cured silver exhibits good adhesion to the PET and anisotropic conductive film, but not to the ITO. The photonically sintered silver electrode exhibited good adhesion to the PET, ITO, and anisotropic conductive film. During removal of the flexible printed circuit, a cohesive failure of the anisotropic conductive film occurred, which indicated that the photonically sintered silver electrode would not be the weakest link in the layer construction.

### Example 3

### Flexural Strength and Electrical Continuity of Ink Jetted Conductive Patterns

Flexural strength and electrical continuity of ink jetted conductive electrodes were evaluated using optimized settings (determined from the printability and curability evaluations) to produce sensor stacks. The electrode geometry that was selected for these experiments was geometry A from FIG. 4. A matrix of pressure (8 kilograms per square centimeter (kg/cm²), 16 kg/cm², and 24 kg/cm²) and temperature (120° C., 140° C., and 160° C.) settings was evaluated.

Resistance values were measured for each electrode from the controller side of the flexible printed circuit through one ITO diamond. The resulting data was plotted on a contour plot. Each contour plot was compared to a standard sensor assembly without conductive ink.

A manual peel was completed to remove the flexible printed circuit from the electrode, and the electrodes were cleaned with acetone and a cotton swab. Each electrode was then examined under magnification to determine if cracking was present. If cracking was present, the mode of failure responsible was determined: i) embossing of the copper pad from the flexible printed circuit; ii) glass particles of the anisotropic conductive film; or iii) polyimide flexible printed circuit cover lay.

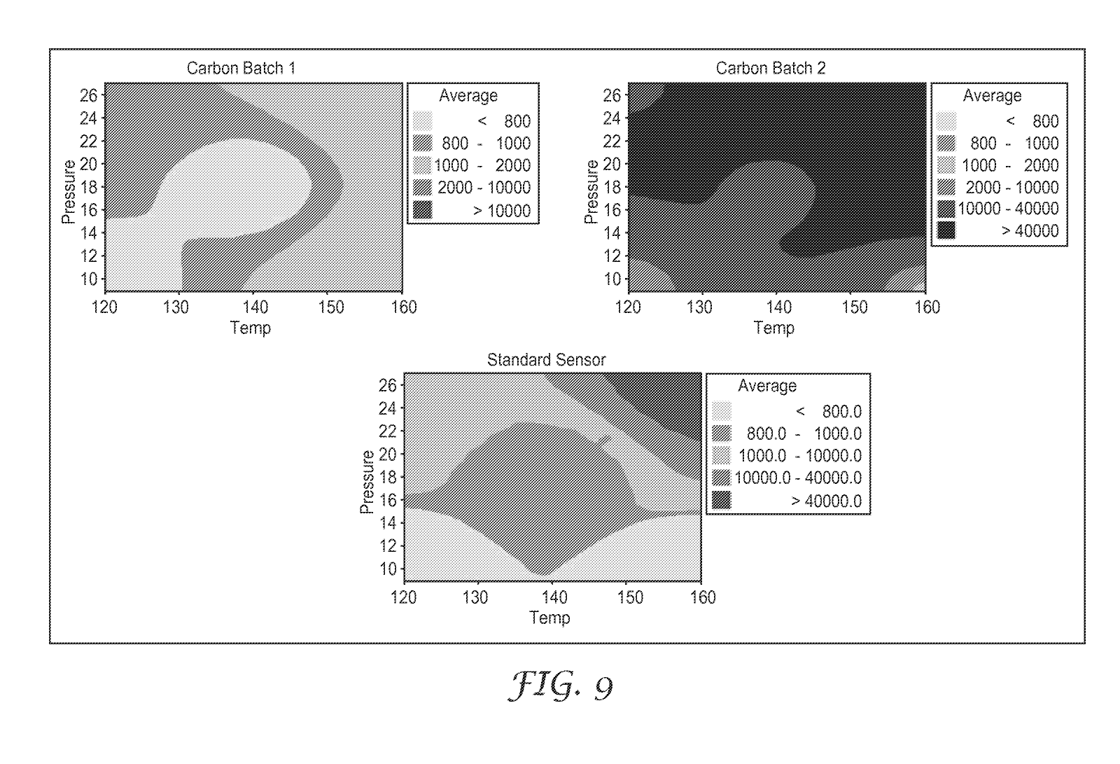

Two batches of carbon 3800 were evaluated for flexural strength and electrical continuity. Contour maps of the results are shown in FIG. 9. The electrodes constructed with carbon batch 1 were able to maintain a lower resistance at similar pressures when compared to the standard sensor. With respect to temperature, the carbon batch 1 electrode construction was not able to withstand the upper temperature limits while maintaining conductivity. All layers above the ITO were removed to facilitate microscopy. The carbon batch 2 electrode which underwent the flexible printed circuit attachment process at low pressure and low temperature did not exhibit any cracking. At high pressure and low temperature, the ITO cracked due to all three failure modes: copper pad embossing, glass particle impression, and polyimide layer impression. The carbon batch 1 electrode which underwent the flexible printed circuit attachment process at low pressure and high temperature exhibited cracking due to glass particle impression and polyimide layer impression. At high pressure and high temperature, the ITO cracked due to all 3 failure modes: copper pad embossing, glass particle impression, and polyimide layer impression.

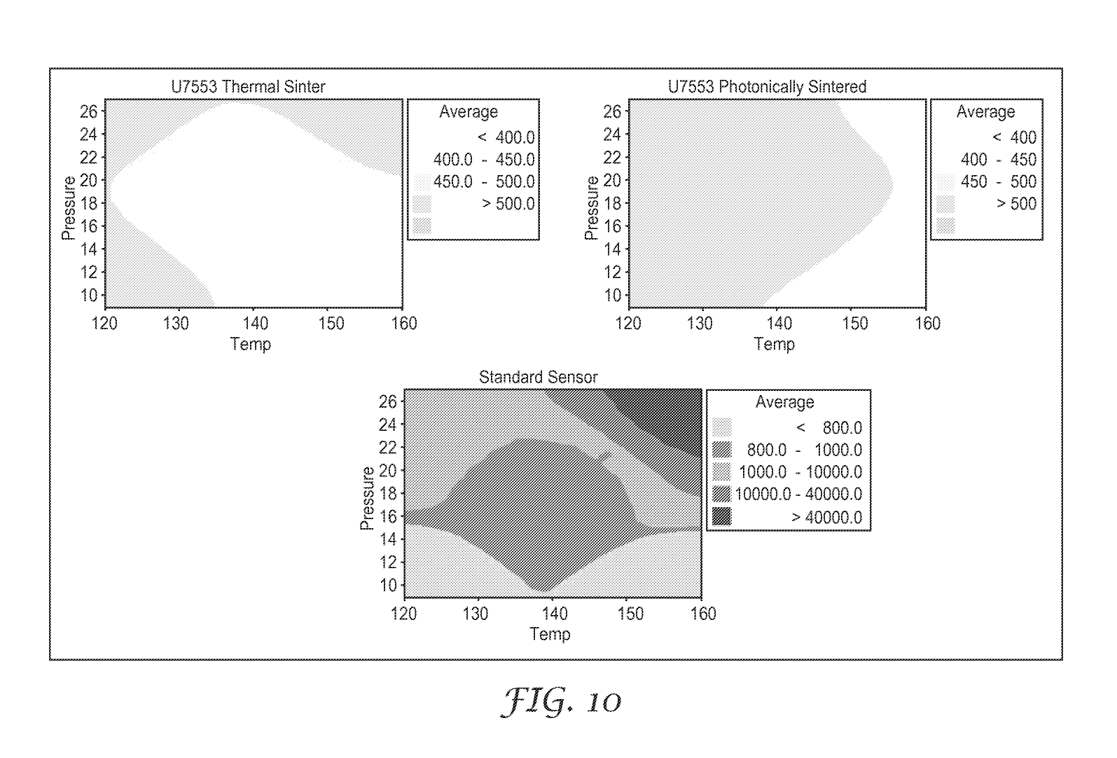

Both photonic and thermal sintering processes for silver ink were evaluated, and contour maps of the results are shown in FIG. 10. Both sintering processes for silver ink yielded electrodes which were able to withstand the full range of temperatures and pressures examined in this test while maintaining conductivity. At all conditions, the silver electrode outperformed the standard sensor construction. The silver thermally sintered electrode that underwent the flexible printed circuit attachment process at low pressure and low temperature did not exhibit any cracking. At high pressure and low temperature, the ITO cracked due to all 3 failure modes: copper pad embossing, glass particle impression, and polyimide layer impression.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the mechanical, electro-mechanical, and electrical arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

1. A multilayer stack for use in a touch sensor and having a border area surrounding a viewing area, the viewing area adapted to face a viewer and be touch sensitive, the multilayer stack comprising:
a base substrate covering the viewing and border areas of the multilayer stack;
an optically opaque border layer disposed in and covering the border, but not the viewing, area of the multilayer stack, the border layer defining a step proximate to and extending along a perimeter of the viewing area and having a step height of at least 5 microns;
an optically transparent adhesive layer disposed on the base substrate and the border layer and covering the viewing and border areas of the multilayer stack, a maximum height variation of a major surface of the optically transparent adhesive layer away from the viewing area in a region corresponding to the step being less than the step height;
a plurality of discrete spaced apart optically transparent electrodes disposed on the adhesive layer, each electrode extending across the step; and
a plurality of discrete spaced apart electrically conductive pads disposed in the border, but not the viewing, area of the multilayer stack, each pad being disposed on and making physical contact with a different corresponding electrode over a contact region.

2. The multilayer stack of claim 1, wherein the adhesive layer is at least 30 microns thick.

3. The multilayer stack of claim 1, wherein any void or bubble formed between the base substrate, the optically opaque border layer and the optically transparent adhesive layer at the step is substantially unresolvable by a human eye at a normal viewing distance.

4. The multilayer stack of claim 1, wherein at least one electrode is cracked in the contact region between the electrode and the pad corresponding to the electrode, resulting in the electrode being electrically non-continuous across the crack, the pad providing electrical continuity across the crack.

5. The multilayer stack of claim 1, wherein from a top view of the multilayer stack, any void or bubble formed between the base substrate, the optically opaque border layer and the optically transparent adhesive layer at the step has a maximum dimension of 20 mm along a direction parallel to the perimeter of the viewing area and a maximum dimension of 1.5 mm along a direction perpendicular to the perimeter of the viewing area.

6. The multilayer stack of claim 1, wherein the conductive pads are printed on corresponding electrodes.

7. A multilayer stack for use in a touch sensor and having a border area surrounding a viewing area, the viewing area adapted to face a viewer and be touch sensitive, the multilayer stack comprising:
a base substrate covering the viewing and border areas of the multilayer stack;
an optically opaque border layer disposed in and covering the border, but not the viewing, area of the multilayer stack, the border layer defining a step proximate to and extending along a perimeter of the viewing area and having a step height of at least 5 microns;
an optically transparent adhesive layer disposed on the base substrate and the border layer and covering the viewing and border areas of the multilayer stack;
a plurality of discrete spaced apart optically transparent electrodes disposed on the adhesive layer, each electrode extending across the step; and
a plurality of discrete spaced apart electrically conductive pads disposed in the border, but not the viewing, area of the multilayer stack, each pad being disposed on and making physical contact with a different corresponding electrode over a contact region, wherein any void or bubble formed between the base substrate, the optically opaque border layer and the optically transparent adhesive layer at the step is substantially unresolvable by a human eye viewing the multilayer stack at a normal viewing distance.

8. A touch sensor having a touch sensitive area surrounded by a border area, a vertical step separating the border area from the touch sensitive area and extending along a perimeter of the touch sensitive area, the step having a step height of at least 5 microns, an optically transparent adhesive layer disposed on and covering the touch sensitive and border areas and having a minimum thickness of at least 30 microns, an optically transparent electrode disposed on the optically transparent adhesive layer in the border area and extending across the vertical step, and an electrically conductive pad disposed on the electrode in the border area.

9. The touch sensor of claim 8, wherein the optically transparent electrode comprises a crack near the step resulting in the electrode being electrically non-continuous across the crack, the electrically conductive pad providing electrical continuity across the crack.

10. The touch sensor of claim 9, wherein a maximum height variation of a major surface of the optically transparent adhesive layer away from the touch sensitive area in a region corresponding to the vertical step is less than the step height.

11. The multilayer stack of claim 1, wherein at least portions of the border area are adapted to be touch insensitive.

12. The multilayer stack of claim 1, wherein each electrode extends across substantially the entire viewing area.

13. The multilayer stack of claim 1, wherein a storage modulus of the optically transparent adhesive layer is not greater than about 1.75×10⁵.

14. The multilayer stack of claim 1, wherein an optical density of the optically opaque border layer is at least 2.

15. The multilayer stack of claim 1, wherein the step height is at least 7 microns.

16. The multilayer stack of claim 1, wherein each optically transparent electrode comprises a plurality of alternating wider sense electrodes and narrower connecting bars.

17. The multilayer stack of claim 16, wherein each wider sense electrode is diamond shaped.

18. The multilayer stack of claim 16, wherein each electrically conductive pad is disposed on a sense electrode of the corresponding electrode.

19. The multilayer stack of claim 7, wherein the adhesive layer substantially planarizes the step such that a major surface of the adhesive layer away from the base substrate is substantially planar in a region corresponding to the step.

20. The touch sensor of claim 8, wherein the optically transparent electrode extends across substantially the entire viewing area.

21. The touch sensor of claim 8 further comprising a flexible printed circuit electrically connected to the conductive pads via a conductive adhesive.
